(19) United States
(12) Patent Application Publication
(10) Pub. No.: US 2025/0025785 A1
(43) Pub. Date: Jan. 23, 2025

(54) GAME STORE DISPLAY METHOD AND APPARATUS, DEVICE, MEDIUM, AND PROGRAM PRODUCT

(71) Applicant: TENCENT TECHNOLOGY (SHENZHEN) COMPANY LIMITED, Shenzhen (CN)

(72) Inventor: Ye KUANG, Shenzhen (CN)

(21) Appl. No.: 18/908,528

(22) Filed: Oct. 7, 2024

Related U.S. Application Data
(63) Continuation of application No. PCT/CN2023/119354, filed on Sep. 18, 2023.

(30) Foreign Application Priority Data
Nov. 15, 2022 (CN) 202211431437.1

(51) Int. Cl. A63F 13/537; A63F 13/822

(52) U.S. Cl. CPC A63F 13/537; A63F 13/822

(57) ABSTRACT

This application discloses a game store display method and apparatus, a device, a medium, and a program product, and belongs to the field of human-computer interaction. The game store display method includes refreshing a display of a virtual chess piece for sale in the game store based on a refresh condition in a turn-based chess game; controlling a first game account to participate in a turn in the turn-based chess game using a purchased virtual chess piece in response to a purchase operation and a game operation; and displaying prompt information that suggests configuring the game store to be in a locked state when the game store meets a locking prompting condition, wherein the locked state is a state in which the game store locks a virtual chess piece for sale without refreshing within locking duration.

### RELATED APPLICATIONS

This application is continuation of PCT Application No. PCT/CN2023/119354, filed on Sep. 18, 2023, which in turn claims priority to Chinese Patent Application No. 202211431437.1, filed on Nov. 15, 2022, and entitled “GAME STORE DISPLAY METHOD AND APPARATUS, DEVICE, MEDIUM, AND PROGRAM PRODUCT”, which are incorporated herein by reference in their entirety.

### FIELD OF THE TECHNOLOGY

Embodiments of this application relate to the field of human-computer interaction, and in particular, to a game store display method and apparatus, a device, a medium, and a program product.

### BACKGROUND OF THE DISCLOSURE

A type of electronic strategy chess and card game is referred to as the auto chess game. A basic game rule of the auto chess game is that a player selects and combines different types of virtual chess pieces by drawing the virtual chess pieces and then arranges the virtual chess pieces on a chessboard of the player, and finally a game system automatically controls the virtual chess pieces of the player to battle with a virtual chess piece of an opponent until a player who still has a surviving virtual chess piece at the end wins the game.

In the process of drawing a virtual chess piece in the auto chess game, a game store automatically refreshes a virtual chess piece at every turn, and displays a virtual chess piece different from that in the previous turn. A player often cannot purchase a desired virtual chess piece refreshed in the game store immediately.

In this case, the player can trigger a locking button to lock a virtual chess piece for sale in a game store, and then the player can purchase the locked virtual chess piece in the next turn. However, at a later stage of a battle of the auto chess game, the player obtains more information and performs more operations and the player may further focus on other information, then the player can forget to trigger the locking button, resulting in missing purchasing the desired chess piece.

### SUMMARY

This application provides a game store display method and apparatus, a device, a medium, and a program product. Technical solutions are as follows:

One aspect of embodiments of this application provides a game store display method is provided. The method is performed by a terminal. The method includes refreshing a display of a virtual chess piece for sale in the game store based on a refresh condition in a turn-based chess game; controlling a first game account to participate in a turn in the turn-based chess game using a purchased virtual chess piece in response to a purchase operation and a game operation; and displaying prompt information that suggests configuring the game store to be in a locked state when the game store meets a locking prompting condition, wherein the locked state is a state in which the game store locks a virtual chess piece for sale without refreshing within locking duration.

Another aspect of embodiments of this application provides a computer device is provided. The computer device includes: a processor and a memory, the memory storing a computer program, and the computer program being loaded and executed by the processor to implement the game store display method according to the foregoing aspect.

Another aspect of embodiments of this application provides a non-transitory computer-readable storage medium is provided. The computer-readable storage medium stores at least one instruction. The at least one instruction is loaded and executed by a processor to implement the game store display method according to the foregoing aspect.

The technical solutions provided in the embodiments of this application may provide the following beneficial effects. When the game store meets the locking prompting condition, the prompt information that suggests configuring the game store to be in the locked state is displayed, so that a player can perform a locking operation based on the prompt information. At a later stage of a battle of the game, even if there is a large amount of information and operations to be performed, the player will not miss a desired chess piece.

In addition, the first game account controlled by the player obtains the desired chess piece, which facilitates improving battle strength of the first game account and reducing battle time of the game, further reducing computer resources consumed in one battle.

### BRIEF DESCRIPTION OF THE DRAWINGS

FIG. 1 is a schematic diagram of a computer system according to an embodiment of this application.

FIG. 2 is a schematic diagram of a game store display method according to an embodiment of this application.

FIG. 3 is a flowchart of a game store display method according to an embodiment of this application.

FIG. 4 is a flowchart of a game store display method according to an embodiment of this application.

FIG. 5 is a flowchart of a game store display method according to an embodiment of this application.

FIG. 6 is a flowchart of a game store display method according to an embodiment of this application.

FIG. 7 is a flowchart of a game store display method according to an embodiment of this application.

FIG. 8 is a schematic diagram of a game store display method according to an embodiment of this application.

FIG. 9 is a schematic diagram of a game store display method according to an embodiment of this application.

FIG. 10 is a schematic diagram of a game store display method according to an embodiment of this application.

FIG. 11 is a schematic diagram of a game store display method according to an embodiment of this application.

FIG. 12 is a block diagram of a game store display apparatus according to an embodiment of this application.

FIG. 13 is a schematic diagram of a structure of a computer device according to an embodiment of this application.

### DESCRIPTION OF EMBODIMENTS

Some key terms in this application are briefly introduced below:

Turn-based chess game: a form of chess games in which a player and an opponent play the game by operating their respective virtual chess pieces in turns.

Auto chess: a collective term of electronic strategy turn-based chess and card games. A basic game rule of the auto chess is that a player selects and combines different types of virtual chess pieces by drawing the virtual chess pieces and then arranges the virtual chess pieces on a chessboard of the player, and finally a game system automatically controls the virtual chess pieces of the player to battle with a virtual chess piece of an opponent until a player who still has a surviving virtual chess piece at the end wins this turn. A hit point (HP) of the loser in each turn is reduced by a specific amount. This process is repeated multiple times until only one of the multiple players survives.

Virtual chess piece: a chess piece arranged on a chessboard in an auto chess game, including a combat virtual chess piece and a preparation virtual chess piece. The combat virtual chess piece is a virtual chess piece in a combat region. The preparation virtual chess piece is a virtual chess piece in a preparation region.

Chessboard: a region for preparing for battles and conducting battles in a battle interface of an auto chess game, which may be any one of a two-dimensional virtual chessboard, a 2.5-dimensional virtual chessboard, and a three-dimensional virtual chessboard. This is not limited in this application. The chessboard is divided into a combat region and a preparation region. The combat region includes several battle chess squares of the same size. The battle chess square is configured for placing a combat virtual chess piece for a battle process. The preparation region includes several preparation chess squares. The preparation chess square is configured for placing a preparation virtual chess piece. The preparation virtual chess piece does not participate in a battle process, but may be dragged and placed in the combat region in a preparation phase.

For example, for a method of setting the battle chess squares in the combat region, in one embodiment, the combat region includes n (rows)×m (columns) of battle chess squares, where n is an integer multiple of 2, and two adjacent rows of battle chess squares are aligned or two adjacent rows of battle chess squares are interleaved. In addition, the combat region is divided into two parts according to the rows, namely a player's own combat region and an enemy combat region, and the player can only place a virtual chess piece in the player's own combat region in the preparation phase.

Coin: a basic resource (virtual resource) for purchasing a virtual chess piece and refreshing a game store in the game. In each turn, a user receives basic coins and 10% of current coins as interest (where maximum interest is 5, and there is no interest if there are fewer than 10 coins), and additional coins are obtained based on the number of consecutive victories or defeats.

Preparation region: After a player obtains a virtual chess piece, the virtual chess piece remains in a preparation region. The player may sell, move, or keep the virtual chess piece in the preparation region. There is an upper limit to the capacity of the preparation region for virtual chess pieces.

Star up: When N same virtual chess pieces exist in a combat region and a preparation region of the auto chess game, the virtual chess pieces are merged automatically into a virtual chess piece of a higher star level. This process is referred to as star up. After star up, chess squares in the combat region and the preparation region are freed. The virtual chess piece after star up increases strength significantly. N is a positive integer. For example, three same one-star virtual chess pieces can be upgraded automatically to a two-star virtual chess piece; and three same two-star virtual chess pieces can be upgraded automatically to a three-star virtual chess piece. The highest star level of a virtual chess piece is three-star. The upgrade to one three-star virtual chess piece requires a total of nine one-star virtual chess pieces. The upgraded virtual chess piece increases basic attributes and skill strength significantly. A player can purchase a one-star virtual chess piece in a game store, but cannot purchase two-star and three-star virtual chess pieces directly.

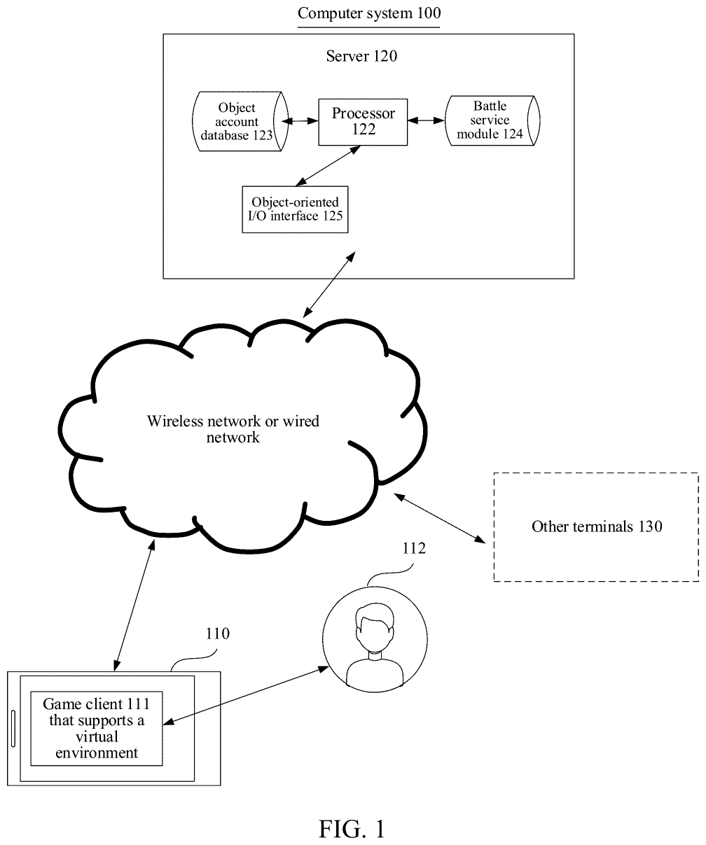

FIG. 1 is a schematic diagram of a computer system 100 according to an embodiment of this application. The computer system 100 includes: a terminal 110 and a server 120.

A game client 111 that supports a virtual environment is installed and run in the terminal 110. The game client 111 may be a multiplayer online battle program. When the terminal 110 runs the game client 111, an object interface of the game client 111 is displayed on a screen of the terminal 110. The game client 111 may be any one of a virtual reality (VR) application program, an augmented reality (AR) program, a three-dimensional map program, a virtual reality game, an augmented reality game, a first-person shooting (FPS) game, a third-person shooting (TPS) game, a multiplayer online battle arena (MOBA) game, and a strategy chess and card game. In this embodiment, using an example in which the game client 111 is a strategy chess and card game for description, the terminal 110 is a terminal used by an object 112.

The terminal 110 may refer generally to one of multiple terminals. This embodiment only uses the terminal 110 as an example for description. A device type of the terminal 110 includes at least one of a smartphone, a wearable device, an on-board terminal, a smart television, a tablet computer, an ebook reader, an MP3 player, an MP4 player, a laptop portable computer, and a desktop computer.

FIG. 1 only shows one terminal, but there may be multiple other terminals 130 in different embodiments to access the server 120. In one embodiment, there may be one or more other terminals 130 being terminals corresponding to developers. A development and editing platform for a game client that supports a virtual environment is installed in the other terminals 130. The developers may edit and update the game client 111 on the other terminals 130, and transmit an installation package of the updated game client 111 to the server 120 through a wired or wireless network. The terminal 110 may download the installation package of the game client from the server 120 to update the game client.

The terminal 110 and the other terminals 130 are connected to the server 120 through a wireless network or a wired network.

The server 120 includes at least one of one server, multiple servers, a cloud computing platform, and a virtualization center. The server 120 is configured to provide a backend service for the game client that supports the three-dimensional virtual environment. In one embodiment, the server 120 undertakes primary computing work, and the terminal 110 undertakes secondary computing work; or the server 120 undertakes secondary computing work, and the terminal 110 undertakes primary computing work; or the server 120 and the terminal 110 perform cooperative computing by using a distributed computing architecture.

In one embodiment, the server 120 includes a processor 122, an object account database 123, a battle service module 124, and an object-oriented input/output interface (I/O interface) 125. The processor 122 is configured to load instructions stored in the server 120 and process data in the object account database 123 and the battle service module 124. The object account database 123 is configured to store data of object accounts used by the terminal 110 and the other terminals 130, such as a profile photo of an object account, a nickname of an object account, a combat effectiveness index of an object account, and a service area where an object account is located. The battle service module 124 is configured to provide multiple battle modes for objects to battle, such as a 1V1 battle mode, a 3V3 battle mode, a 5V5 battle mode, or a battle mode in which one or more objects form one camp, then multiple (three or more) camps battle with each other, and the camps are ranked and eliminated based on battle results to finally determine the ranking. The object-oriented I/O interface 125 is configured to establish communication and exchange data with the terminal 110 and/or the other terminals 130 through a wireless network or a wired network.

There is a strategy chess and card game referred to as an auto chess game among various types of network games. A basic game rule of the auto chess game is that a player selects and combines different types of virtual chess pieces by drawing the virtual chess pieces and then arranges the virtual chess pieces on a chessboard of the player, and finally a game system automatically controls the virtual chess pieces of the player to battle with a virtual chess piece of an opponent until a player who still has a surviving virtual chess piece at the end wins this turn. A hit point of the loser in each turn is reduced by a specific amount. This process is repeated for multiple times until only one of the multiple players survive.

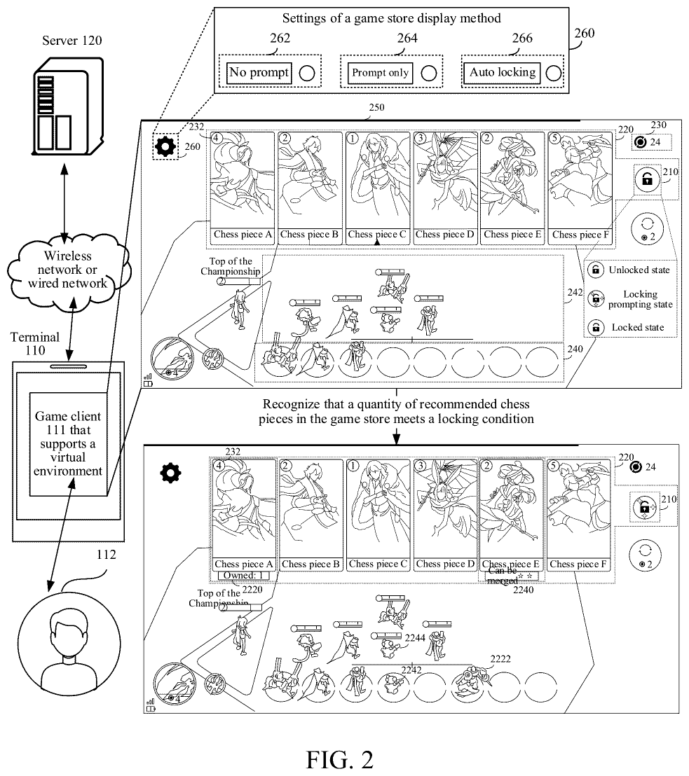

In the process of drawing a virtual chess piece in an auto chess game, a player may increase a quantity of selectable virtual chess pieces by refreshing a game store, but often encounter a situation in which a desired virtual chess piece that is refreshed cannot be purchased immediately. As the game store is automatically refreshed at the end of each turn, to prevent missing the desired virtual chess piece, in the method provided in this application, the game store display method is set to reduce the possibility of the player missing the desired virtual chess piece. FIG. 2 is a schematic diagram of a game store display method according to an embodiment of this application.

A game client 111 that supports a virtual environment is installed and run in a terminal 110. The game client 111 reads different game parameters in a game interface. The game interface includes at least one of the following: a locking button 210, a game store 220, an owned coin quantity 230, a quantity 232 of coins consumed for purchasing a single virtual chess piece, a preparation region 240, a time progress bar 250, and a setting button 260.

The status of the locking button 210 includes at least one of the following: an unlocked state, a locking prompting state, and a locked state. The locking button 210 in the unlocked state is presented as a lock-type button of an unlocked style. The locking button 210 in the locking prompting state is presented as a lock-type button of a blinking lock-type button of an unlocked style. The locking button 210 in the locked state is presented as a lock-type button of a locked style.

The game store 220 includes the locking button 210 and a virtual chess piece selectable for the player, such as a chess piece A, a chess piece B, and a chess piece C. A quantity of virtual chess pieces selectable for the player is variable. For example, if a quantity of virtual chess pieces selectable for the player is 6, the virtual chess pieces selectable for the player are a chess piece A, a chess piece B, a chess piece C, a chess piece D, a chess piece E, and a chess piece F respectively.

The owned coin quantity 230 is a quantity of coins currently owned by the player, which is a specific integer value. The quantity 232 of coins consumed for purchasing a single virtual chess piece is a specific integer value. Quantities of coins consumed for purchasing different virtual chess pieces may be the same or may be different. For example, the owned coin quantity 230 is 24, and a quantity of coins consumed for purchasing the chess piece A is 4.

The preparation region 240 is a region for keeping a virtual chess piece obtained by the player. The player may perform an operation such as selling, moving, or keeping on the virtual chess piece in the preparation region 240. There is an upper limit to the quantity of positions in the preparation region 240. A combat region 242 is above the preparation region 240. The combat region 242 is a region for the virtual chess pieces to conduct a combat. For example, the preparation region 240 currently has an upper limit of eight positions, with three virtual chess pieces staying and five positions free.

The time progress bar 250 is configured to indicate the remaining time of a current phase. The game process includes a combat phase, a preparation phase, and a buffer phase. The combat phase is after the preparation phase. The buffer phase is after the combat phase. The preparation phase is after the buffer phase. The game store 220 is automatically refreshed in the preparation phase to change the virtual chess pieces selectable for the player.

Different players have different needs for the game store display method. In this case, a customization setting of the game store display method is added to settings, so that the player can select different game store display methods as required. The setting button 260 includes a no-prompt mode 262, a prompt-only mode 264, and an auto-locking mode 266.

The no-prompt mode 262 includes no-prompt text and a selection button.

The prompt-only mode 264 includes prompt-only text and a selection button.

The auto-locking mode 266 includes auto-locking text and a selection button.

When the player does not require a locking prompt, the player selects the no-prompt mode 262. In this case, when the terminal displays the locking button as being in the locking prompting state, the terminal displays the locking button as being in the unlocked state. For example, when the player does not like the prompting function of the locking button, the player selects the no-prompt mode 262. In this case, when the terminal displays the locking button as being in the locking prompting state, the terminal displays the locking button as being in the unlocked state.

When the player only requires a locking prompt, the player selects the prompt-only mode 264. In this case, when the terminal displays the locking button as being in the locking prompting state, the terminal displays the locking button as being in the locking prompting state. For example, when the player needs assistance from the game system but does not need the game system to completely take over the locking function of the game store, the player selects the prompt-only mode 264. In this case, when the terminal displays the locking button as being in the locking prompting state, the terminal displays the locking button as being in the locking prompting state.

When the player requires automatic locking, the player selects the auto-locking mode 266. In this case, when the terminal displays the locking button as being in the locking prompting state, the terminal displays the locking button as being in the locked state. For example, when the player is very unfamiliar with the game and needs the game system to completely take over the locking function of the game store, the player selects the auto-locking mode 266. In this case, when the terminal displays the locking button as being in the locking prompting state, the terminal displays the locking button as being in the locked state.

In the game, the player encounters a situation in which a desired virtual chess piece that is refreshed cannot be purchased immediately. As the game store is automatically refreshed at the end of each turn, to prevent missing the desired virtual chess piece, the game client displays prompt information that suggests configuring the game store to be in the locked state. For this purpose, the game client reads a quantity of recommended chess pieces of the game store and a value of a game parameter, and calculates whether the quantity of recommended chess pieces of the game store and the value of the game parameter meet a locking prompting condition.

In the game, the player needs to improve the combat effectiveness of the virtual chess piece to defeat the enemy and win the game. To improve the combat effectiveness, it is necessary to draw a recommended chess piece. The recommended chess piece includes at least one of a virtual chess piece owned by the player, a virtual chess piece that meets a star up condition, and a virtual chess piece that matches a lineup used by the player.

The game parameter includes at least one of the following:
a quantity of virtual resources owned by the first game account;
a quantity of virtual resources required to purchase all of the recommended chess pieces;
a quantity of remaining positions in a preparation region; and
remaining time for a combat phase.

The virtual resources are resources for purchasing the virtual chess piece in the turn-based chess game; the preparation region is a region storing the virtual chess piece; and the combat phase is a phase in a turn in the turn-based chess game.

When the game client recognizes that the quantity of recommended chess pieces of the game store meets a recommendation condition, for example, the game store includes a chess piece A 2220 and a chess piece E 2240, the preparation region includes a chess piece A1 2222 and a chess piece E1 2242, and the combat region includes a chess piece E2 2244. The chess piece A 2220 and the chess piece A1 2222 are different picture representations of one same type of virtual chess pieces. The chess piece E 2240, the chess piece E1 2242, and the chess piece E2 2244 are different picture representations of another same type of virtual chess pieces. In this case, the chess piece A 2220, as the virtual chess piece owned by the player, meets the condition of being a recommended chess piece, and the chess piece E 2240, as the virtual chess piece that meets the star up condition, meets the condition of being a recommended chess piece.

When the game store includes the recommended chess piece, the game client determines the state of the locking button 210 as the locking prompting state.

In conclusion, in the method provided in one embodiment, when the game store meets the locking prompting condition, the prompt information that suggests configuring the game store to be in the locked state is displayed, so that a player can perform a locking operation based on the prompt information. At a later stage of a battle of the game, even if there is a large amount of information and operations to be performed, the player does not miss a desired chess piece. In addition, the first game account controlled by the player obtains the desired chess piece, which facilitates improving battle strength of the first game account and reducing battle time of the game, further reducing computer resources consumed in one battle.

In the method provided in this embodiment, the customization setting of the game store display method is added to the settings, so that the player can select different game store display methods as required, such as automatic locking or locking prompting, meeting requirements of different players on the locking prompting function.

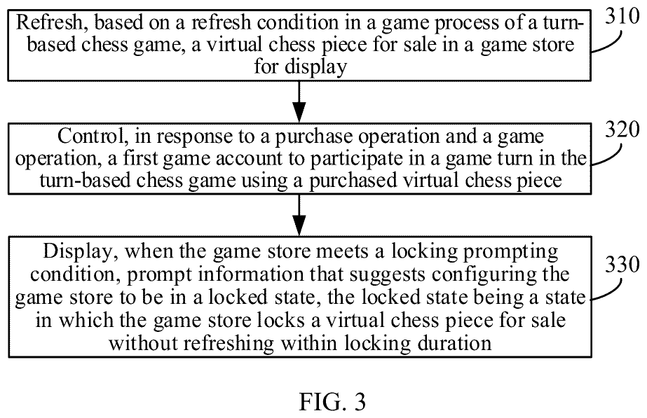

FIG. 3 is a flowchart of a game store display method according to an embodiment of this application. The method is performed by a terminal or a game client. The method includes the following operations:

### Operation 310:

Refresh, based on a refresh condition in a game process of a turn-based chess game, a virtual chess piece for sale in the game store for display.

In this embodiment, a basic game rule of the turn-based chess game is that a player selects and combines different types of virtual chess pieces by drawing the virtual chess pieces and then arranges the virtual chess pieces on a chessboard of the player, and finally a game system automatically controls the virtual chess pieces of the player to battle with a virtual chess piece of an opponent until a player who still has a surviving virtual chess piece at the end wins this turn.

In some embodiments, the refresh condition includes a refresh condition of the player refreshing the game store manually, or a refresh condition of the game client refreshing the game store automatically. Refreshing the game store manually includes that when the player has enough virtual resources to refresh the game store, the player clicks/taps a refresh button on the game interface to refresh the virtual chess piece for sale in the game store for display. The game client refreshing the game store automatically includes that at the end of one turn, the player does not need to click/tap a refresh button on the game interface, and the game client automatically refreshes the virtual chess piece for sale in the game store for display.

Operation 320: Control, in response to a purchase operation and a game operation, a first game account to participate in a turn in the turn-based chess game using a purchased virtual chess piece.

In response to an operation of purchasing the virtual chess piece and a game operation such as moving, selling, or upgrading the virtual chess piece by the player, the game client controls the first game account of the player to participate in the turn in the turn-based chess game using the purchased virtual chess piece.

In some embodiments, the game client obtains a quantity of recommended chess pieces, and recognizes, based on the quantity of recommended chess pieces, whether the game store meets a locking prompting condition. When the game store meets the locking prompting condition, the operation 330 is performed. When the game store does not meet the locking prompting condition, the operation 310 is performed in a preparation phase of a next turn.

In some embodiments, the game client obtains a quantity of recommended chess pieces and a game parameter of the first game account, and recognizes, based on the quantity of recommended chess pieces and the game parameter of the first game account, whether the game store meets a locking prompting condition. When the game store meets the locking prompting condition, the operation 330 is performed. When the game store does not meet the locking prompting condition, the operation 310 is performed.

Operation 330: Display, when the game store meets a locking prompting condition, prompt information that suggests configuring the game store to be in a locked state, the locked state being a state in which the game store locks a virtual chess piece for sale without refreshing within locking duration.

In the turn-based chess game, the player encounters a situation in which a desired virtual chess piece that is refreshed cannot be purchased immediately, that is, a situation in which the game store meets the locking prompting condition.

In some embodiments, the locking prompting condition is configured for recognizing or predicting a scenario in which the desired virtual chess piece is refreshed in the game store but the first game account has insufficient virtual resources for purchasing the virtual chess piece, and/or the locking prompting condition is configured for recognizing or predicting a scenario in which the desired virtual chess piece is refreshed in the game store but there is no position in a current preparation region to keep the desired virtual chess piece. To prevent missing the desired virtual chess piece, when the game store meets the locking prompting condition, the game client displays the prompt information that suggests configuring the game store to be in the locked state.

In conclusion, in the method provided in this embodiment, when the game store meets the locking prompting condition, the prompt information that suggests configuring the game store to be in the locked state is displayed, so that a player can perform a locking operation based on the prompt information. At a later stage of a battle of the game, even if there is a large amount of information and operations to be performed, the player does not miss a desired chess piece.

For the embodiment that combines the quantity of recommended chess pieces and the game parameter of the first game account:

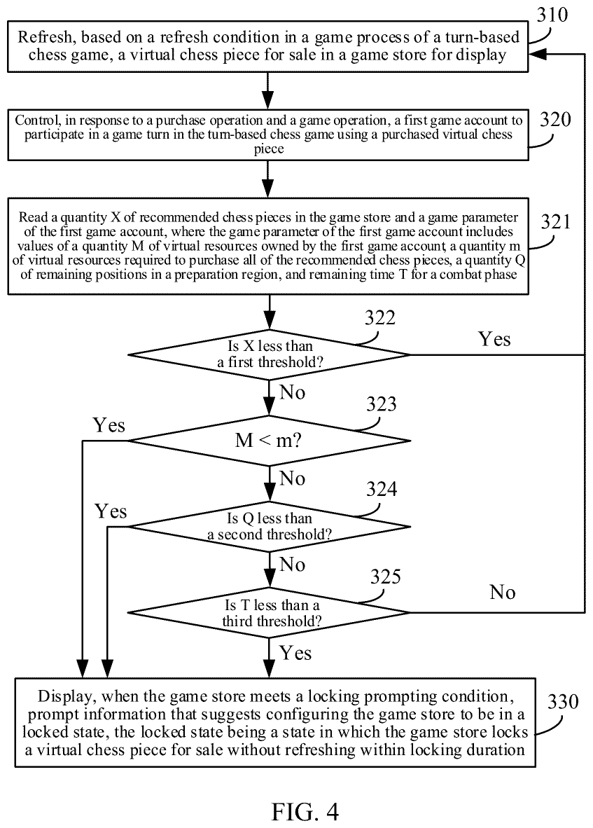

FIG. 4 is a flowchart of a game store display method according to an embodiment of this application. The method is performed by a terminal or a game client. The method includes the following operations:

Operation 310: Refresh, based on a refresh condition in a game process of a turn-based chess game, a virtual chess piece for sale in the game store for display.

Operation 320: Control, in response to a purchase operation and a game operation, a first game account to participate in a turn in the turn-based chess game using a purchased virtual chess piece.

Operation 321: Read a quantity X of recommended chess pieces in the game store and a game parameter of the first game account, where the game parameter of the first game account includes values of a quantity M of virtual resources owned by the first game account, a quantity m of virtual resources required to purchase all of the recommended chess pieces, a quantity Q of remaining positions in a preparation region, and remaining time T for a combat phase.

The recommended chess pieces are virtual chess pieces recommended in the game store to the first game account for purchase. The recommended chess pieces are virtual chess pieces configured for improving combat effectiveness of a lineup used by the first game account, including at least one of the following:
a virtual chess piece owned by the first game account;
a virtual chess piece that meets an upgrade condition, upgrade being a process of merging, when N same virtual chess pieces exist in the game, the N same virtual chess pieces into a virtual chess piece of a higher level, N being a positive integer; and
a virtual chess piece that matches a lineup used by the first game account.

In the game parameter, the virtual resources are resources for purchasing the virtual chess piece in the turn-based chess game; the preparation region is a region storing the virtual chess piece; and the combat phase is a phase in a turn in the turn-based chess game.

### Operation 322:

Determine whether the quantity of the recommended chess pieces in the game store is less than the first threshold.

When the quantity of the recommended chess pieces in the game store is less than the first threshold, the locking prompting condition is not met, and the operation 310 is performed. When the quantity of the recommended chess pieces in the game store is greater than or equal to the first threshold, a magnitude relationship between the quantity of the virtual resources owned by the first game account and the quantity of the virtual resources required to purchase all of the recommended chess pieces is further determined, and the operation 323 is performed.

### Operation 323:

Determine whether the quantity of the virtual resources owned by the first game account is less than the quantity of the virtual resources required to purchase all of the recommended chess pieces.

When the quantity of the virtual resources owned by the first game account is less than the quantity of the virtual resources required to purchase all of the recommended chess pieces, that is, when all of the recommended chess pieces cannot be purchased, the locking prompting condition is met, and the operation 330 is performed. When the quantity of the virtual resources owned by the first game account is greater than or equal to the quantity of the virtual resources required to purchase all of the recommended chess pieces, that is, when all of the recommended chess pieces can be purchased, the locking prompting condition is not met, and the operation 324 is performed.

For example, when the quantity of the virtual resources required to purchase all of the recommended chess pieces is 7, and the quantity of the virtual resources owned by the first game account is 5, which is less than 7, an operation related to a locked state is performed on the game store.

### Operation 324:

Determine whether the quantity of the remaining positions in the preparation region is less than a second threshold.

When the quantity of the remaining positions in the preparation region is less than the second threshold, the locking prompting condition is met, and the operation 330 is performed. When the quantity of the remaining positions in the preparation region is greater than or equal to the second threshold, the locking prompting condition is not met, and the operation 325 is performed.

For example, when the second threshold is 1, and the quantity of the remaining positions in the preparation region is 0, which is less than 1, prompt information that suggests configuring the game store to be in the locked state is displayed.

### Operation 325:

Determine whether the remaining time for the combat phase is less than a third threshold.

The game process includes a preparation phase, a combat phase, and a buffer phase. The combat phase is after the preparation phase. The buffer phase is after the combat phase. The preparation phase is after the buffer phase. The remaining time for the combat phase is calculated by counting down from the time entering the preparation phase. The game store is automatically refreshed in the preparation phase to change the virtual chess pieces selectable for the player.

When the remaining time for the combat phase is less than the third threshold, that is, when the buffer phase is about to be entered and the game store is about to be automatically refreshed, the locking prompting condition is met, and the operation 330 is performed. When the remaining time for the combat phase is greater than or equal to the third threshold, the locking prompting condition is not met, and the operation 310 is performed.

For example, when the third threshold is 0, and the remaining time for the combat phase is −1, which is less than 0, the prompt information that suggests configuring the game store to be in the locked state is displayed.

In some embodiments, when there are recommended chess pieces, a sequence of the operations of determining the magnitude relationship between the quantity of the virtual resources owned by the first game account and the quantity of the virtual resources required to purchase all of the recommended chess pieces, determining the magnitude relationship between the quantity of the remaining positions in the preparation region and the second threshold, and determining the magnitude relationship between the remaining time for the combat phase and the third threshold is adjustable. Details are not described herein again.

In conclusion, in the method provided in this embodiment, whether there are recommended chess pieces is determined. When there are the recommended chess pieces, the prompt information that suggests configuring the game store to be in the locked state is displayed, so that the player can perform a locking operation based on the prompt information. At a later stage of a battle of the game, even if there is a large amount of information and operations to be performed, the player does not miss a desired chess piece.

In the method provided in this embodiment, the magnitude relationship between the quantity of the virtual resources owned by the first game account and the quantity of the virtual resources required to purchase all of the recommended chess pieces is further determined. When the quantity of the virtual resources owned by the first game account is less than the quantity of the virtual resources required to purchase all of the recommended chess pieces, the operation related to the locked state is performed on the game store, so that the player can purchase the desired virtual chess piece after a purchase condition is met, avoiding missing the desired virtual chess piece.

In the method provided in this embodiment, the magnitude relationship between the quantity of the remaining positions in the preparation region and the second threshold is further determined. When the quantity of the remaining positions in the preparation region is less than the second threshold, the operation related to the locked state is performed on the game store, so that the player can purchase the desired virtual chess piece after a purchase condition is met, avoiding missing the desired virtual chess piece.

In the method provided in this embodiment, the magnitude relationship between the remaining time for the combat phase and the third threshold is further determined. When the remaining time for the combat phase is less than the third threshold, the operation related to the locked state is performed on the game store, so that the player can purchase the desired virtual chess piece after a purchase condition is met, avoiding missing the desired virtual chess piece.

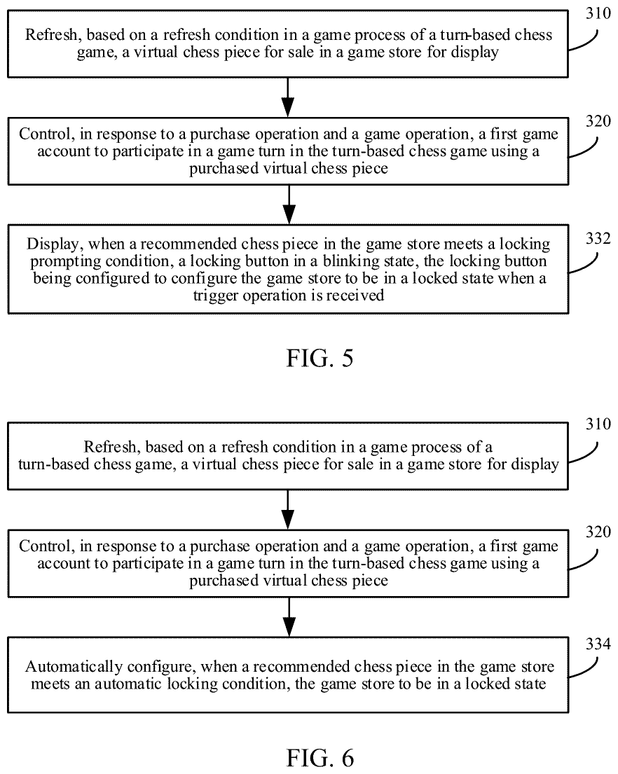

FIG. 5 is a flowchart of a game store display method according to an embodiment of this application. The method is performed by a terminal or a game client. The method includes the following operations:

### Operation 310:

Refresh, based on a refresh condition in a game process of a turn-based chess game, a virtual chess piece for sale in the game store for display.

### Operation 320:

Control, in response to a purchase operation and a game operation, a first game account to participate in a turn in the turn-based chess game using a purchased virtual chess piece.

For the game client recognizing whether a recommended chess piece in the game store meets a locking prompting condition, refer to the relevant description of FIG. 4. Details are not described herein again.

### Operation 332:

Display, when a recommended chess piece in the game store meets a locking prompting condition, a locking button in a blinking state, the locking button being configured to place the game store to be in a locked state when a trigger operation is received.

The blinking state is prompt information for suggesting configuring the game store to be in the locked state.

When the game store meets the locking prompting condition, the game client displays the prompt information. The prompt information indicates, in different manners, a suggestion of configuring the game store to be in the locked state. For example, the prompt information is text information that suggests locking the store, or a locking button in a blinking state, or a locking button in a state significantly different from an unlocked state, or voice information that suggests locking the store.

In a case that the prompt information is a locking button in a blinking state, for example, when the game store includes a recommended chess piece, the game client displays the locking button in the blinking state.

A blinking parameter of the blinking state is related to remaining time T for a combat phase, and the blinking parameter includes at least one of a blinking frequency, blinking brightness, and a blinking color.

A smaller value of T indicates a higher blinking frequency. For example, when T is 9 seconds, the blinking frequency is 2 Hz; or when T is 3 seconds, the blinking frequency is 10 Hz.

Alternatively, a smaller value of T indicates higher blinking brightness. For example, when T is 9 seconds, the blinking brightness is 100 nits; or when T is 3 seconds, the blinking brightness is 200 nits.

Alternatively, a smaller value of T indicates a different blinking color. For example, when T is 9 seconds, the blinking color is green; or when T is 3 seconds, the blinking color is red.

In conclusion, in the method provided in this embodiment, by the method of displaying the locking button in the blinking state when the recommended chess piece in the game store meets the locking prompting condition, the blinking parameter of the blinking state is changed based on the remaining time for the combat phase, prompting the player to lock the game store, so that the player can purchase the desired virtual chess piece after a purchase condition is met, avoiding missing the desired virtual chess piece.

FIG. 6 is a flowchart of a game store display method according to an embodiment of this application. The method is performed by a terminal or a game client. The method includes the following operations:

### Operation 310:

Refresh, based on a refresh condition in a game process of a turn-based chess game, a virtual chess piece for sale in the game store for display.

### Operation 320:

Control, in response to a purchase operation and a game operation, a first game account to participate in a turn in the turn-based chess game using a purchased virtual chess piece.

For the game client recognizing whether a recommended chess piece in the game store meets a locking prompting condition, refer to the relevant description of FIG. 4. Details are not described herein again.

### Operation 334:

Automatically configure, when a recommended chess piece in the game store meets an automatic locking condition, the game store to be in a locked state.

When the recommended chess piece in the game store meets the automatic locking condition, the game client automatically locks the game store, and the virtual chess piece in the game store is not refreshed within locking duration. For example, when the game store includes the recommended chess piece, the game client automatically locks the game store, and the recommended chess piece and another virtual chess piece in the game store are not refreshed. After the game client automatically locks the game store, when a specific unlocking condition is met, the game client unlocks the game store.

The unlocking condition includes at least one of the following:
manual unlocking by the player;
the recommended chess piece in the game store does not meet the automatic locking condition;
locking time or a locking turn quantity reaches a fourth threshold; and
a recommendation degree of a recommended chess piece to be refreshed is higher than a recommendation degree of an existing recommended chess piece.

The recommendation degree is a degree to which the game client recommends the recommended chess piece. For example, the existing recommended chess piece is one virtual chess piece owned by the first game account, and the recommended chess piece to be refreshed is two virtual chess pieces owned by the first game account. In this case, the recommendation degree of the recommended chess piece to be refreshed is higher than the recommendation degree of the existing recommended chess piece.

In conclusion, in the method provided in this embodiment, when the recommended chess piece in the game store meets the automatic locking condition, the game client automatically locks the game store, so that the player can purchase the desired virtual chess piece after a purchase condition is met, avoiding missing the desired virtual chess piece.

In the method provided in this embodiment, when the specific unlocking condition is met, the game client automatically unlocks the game store, thereby making the game process faster and shortening the overall time spent in one battle of the game.

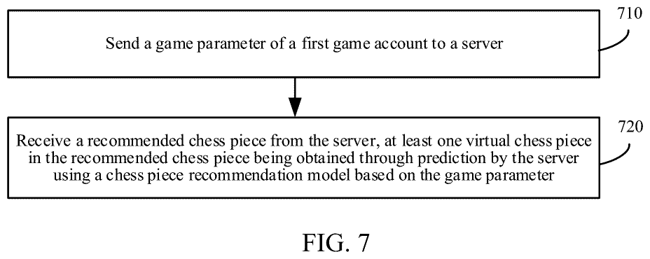

FIG. 7 is a flowchart of a game store display method according to an embodiment of this application. The method is performed by a terminal or a game client. The method includes the following operations:

### Operation 710:

The game client sends a game parameter of a first game account to a server.

The game parameter of the first game account includes at least one of a virtual chess piece owned by the first game account, a quantity of virtual resources owned by the first game account, a virtual chess piece owned by a second game account as an opponent, a quantity of virtual resources owned by the second game account, a sequential position of a current turn throughout the game, and remaining time for a combat phase. The virtual chess piece is referred to as a chess piece for short. For example, there are five virtual chess pieces owned by the first game account, the quantity of virtual resources owned by the first game account is 20 coins, there are eight virtual chess pieces owned by the second game account as the opponent, the quantity of virtual resources owned by the second game account is 10 coins, the sequential position of the current turn throughout the game is the fifth turn, and the remaining time for the combat phase is 15 seconds.

### Operation 720:

The game client receives a recommended chess piece from the server, at least one virtual chess piece in the recommended chess piece being obtained through prediction by the server using a chess piece recommendation model based on the game parameter.

The chess piece recommendation model is obtained through training in the following manner:

A sample battle parameter is obtained. The sample battle parameter includes virtual chess pieces owned by a first sample account at different moments, quantities of virtual resources owned by the first sample account at different moments, virtual chess pieces owned by a second sample account as an opponent at different moments, quantities of virtual resources owned by the second sample account at different moments, and victory or defeat results.

For example, there are five virtual chess pieces owned by the first sample account in the fifth turn, which are a chess piece A₁, a chess piece A₂, a chess piece A₃, a chess piece A₄, and a chess piece As, and there are 15 virtual chess pieces owned by the first sample account in the tenth turn, which are the chess piece A₁, and the chess piece A₂ to a chess piece A₁₅. The quantity of virtual resources owned by the first sample account in the fifth turn is 20 coins, and a quantity of virtual resources owned by the first sample account in the tenth turn is 0 coins. There are eight virtual chess pieces owned by the second sample account as the opponent in the fifth turn, which are a chess piece B₁, and a chess piece B₂ to a chess piece B₈, and there are 13 virtual chess pieces owned by the second sample account in the tenth turn, which are the chess piece B₁, and the chess piece B₂ to a chess piece B₁₃. A quantity of virtual resources owned by the second sample account in the fifth turn is 12 coins, and a quantity of virtual resources owned by the second sample account in the tenth turn is 2 coins. The second sample account wins in the fifth turn, and the first sample account wins in the tenth turn.

When the first sample account wins, a battle parameter corresponding to a first moment in the sample battle parameter is inputted to a temporal feature processing model, to obtain a virtual chess piece predicted to be purchased by the first sample account during next purchase after the first moment. The first moment is any moment in the sample battle. For example, when the first sample account wins, there are two virtual chess pieces owned by the first sample account corresponding to the first moment in the sample battle parameter, which are a chess piece A₁ and a chess piece A₂, and the quantity of virtual resources owned by the first sample account is 5 coins. These battle parameters are inputted to the temporal feature processing model, to obtain virtual chess pieces predicted to be purchased by the first sample account during next purchase after the first moment, which are a chess piece A₃ and a chess piece A₄.

An error loss between the chess piece predicted to be purchased by the first sample account during next purchase after the first moment and an actually purchased chess piece is calculated. For example, the chess pieces predicted to be purchased by the first sample account during next purchase after the first moment are the chess piece A₃ and the chess piece A₄, and the actually purchased chess pieces are the chess piece A₃ and a chess piece As, so that the error loss is 50%.

The temporal feature processing model is trained based on the error loss to obtain the chess piece recommendation model. For example, the error loss is reduced to 5% or less by training the temporal feature processing model, to obtain the chess piece recommendation model.

In conclusion, in the method provided in this embodiment, the chess piece recommendation model is trained based on the game parameter of the first game account to obtain a chess piece recommendation model that meets the requirements, increasing a win rate of the first game account using the recommended chess piece.

The following describes another training method of the chess piece recommendation model.

In one embodiment, the recommended chess piece on which the determination of the game store for providing a locking prompt is based is obtained through prediction by the chess piece recommendation model. Status information of the first game account in a current turn is inputted for the prediction. The status information includes at least one of a type, quantity, and level of a virtual chess piece owned by the first game account, a hit point of the first game account, and a quantity of virtual resources owned by the first game account.

For example, a type identifier of the virtual chess piece owned by the first game account is inputted to a first embedding layer, to obtain a first feature vector. A quantity of virtual chess pieces of all types owned by the first game account is inputted to a second embedding layer, to obtain a second feature vector. Levels of virtual chess pieces of all types owned by the first game account are inputted to a third embedding layer, to obtain a third feature vector. A hit point of the first game account is inputted to a fourth embedding layer, to obtain a fourth feature vector. A quantity of virtual resources owned by the first game account is inputted to a fifth embedding layer, to obtain a fifth feature vector.

The first feature vector to the fifth feature vector is inputted to a fully connected layer, to obtain a fully connected feature vector. The fully connected feature vector is inputted to a decoder, and the decoder outputs the recommended chess piece obtained through prediction.

In one embodiment, the chess piece recommendation model predicts and outputs the recommended chess piece, and the game store determines, based on whether there is the recommended chess piece in chess pieces currently being sold, a quantity of the recommended chess piece, or more reference information, whether to display the prompt information that suggests configuring the game store to be in the locked state. The following describes a training process of the chess piece recommendation model.

In one embodiment, the chess piece recommendation model is trained by using a reinforcement learning framework. The reinforcement learning framework is mainly composed of an agent, an environment, a state, an action, and a reward. After an agent performs an action, the environment changes to a new state, and gives a reward signal (positive or negative) for the new state. Then, the agent performs a new action according to a strategy based on the new state and the reward from the environment. The foregoing process is a method in which the agent and the environment interact with each other based on the state, the action, and the reward.

In one embodiment, when the chess piece recommendation model is trained, historical player battle data is used as a training sample set.

A plurality of sets of battle data of a plurality of sample game accounts are obtained, the plurality of sets of battle data and the plurality of sample game accounts are in a one-to-one correspondence, and one set of battle data includes relevant data of one battle. An example in which the chess piece recommendation model is trained based on one set of battle data of one sample game account is used for description as follows.

In the training process, for a (j+1)^{th} turn, in a preparation phase of the (j+1)^{th} turn, status information of the sample game account at an end of a j^{th} turn is inputted to the chess piece recommendation model, and the chess piece recommendation model predicts a recommended chess piece. There are two cases in which the sample game account purchases the recommended chess piece and the sample game account does not purchase the recommended chess piece. The sample game account is controlled to perform a combat phase in the (j+1)^{th} turn. Status information of the sample game account at the end of the (j+1)^{th} turn is obtained. A turn loss of the (j+1)^{th} turn, that is, a (j+1)^{th} turn loss, is constructed based on a difference between the status information at the end of the j^{th} turn and the status information at the end of the (j+1)^{th} turn, and indication information of whether the sample game account purchases the recommended chess piece in the (j+1)^{th} turn. One turn includes a preparation phase and a combat phase. In the preparation phase, operations such as purchasing a chess piece are performed. The combat phase includes a phase in which a virtual chess piece conducts a combat.

For example, when the sample game account purchases the recommended chess piece, if a hit point of the sample game account after performing the combat phase in the (j+1)^{th} turn is higher than a hit point of the sample game account before performing the combat phase in the (j+1)^{th} turn, a positive reward is given to the sample game account to encourage the sample game account to purchase the recommended chess piece.

For example, when the sample game account does not purchase the recommended chess piece, if coins of the sample game account after performing the combat phase in the (j+1)^{th} turn are more than coins of the sample game account before performing the combat phase in the (j+1)^{th} turn, a positive reward is given to the sample game account to encourage the sample game account not to purchase the recommended chess piece.

For example, when the sample game account purchases the recommended chess piece, if a matching degree of a lineup of the sample game account (the lineup of the sample game account at the end of the (j+1)^{th} turn) after the purchase is higher than a matching degree of a lineup of the sample game account (the lineup of the sample game account at the end of the j^{th} turn) before the purchase, a positive reward is given to the sample game account to encourage the sample game account to purchase the recommended chess piece. A specific lineup combination is pre-configured in an auto chess game. The specific lineup combination may obtain an additional gain. The matching degree of the lineup is the completion progress of reaching the specific lineup combination.

For example, when the sample game account does not purchase the recommended chess piece, if a dispersion degree of a lineup of the sample game account (the lineup of the sample game account at the end of the (j+1)^{th} turn) after the purchase is higher than a dispersion degree of a lineup of the sample game account (the lineup of the sample game account at the end of the j^{th} turn) before the purchase, a negative reward is given to the sample game account to discourage the sample game account not to purchase the recommended chess piece. Multiple specific lineup combinations are pre-configured in an auto chess game. The dispersion degree of the lineup is a quantity of specific lineup combinations that can be combined.

The foregoing describes the process of generating one corresponding turn loss for one turn. In the training process, one complete set of data for one battle is obtained. For multiple turns, the chess piece recommendation model continuously predicts a recommended chess piece and generates a turn loss of each turn. When a turn loss of the last turn is generated, a battle loss is additionally generated. A weighting operation is performed on multiple turn losses and the battle loss. A model parameter of the chess piece recommendation model is updated based on the weighted multiple turn losses and battle loss.

The battle loss is a loss generated based on a battle winning state of the sample game account in a current battle. For example, if the sample game account wins, the battle loss is 0; or if the sample game account loses, the battle loss is 10.

In conclusion, a method for training a chess piece recommendation model is provided. In this case, the recommended chess piece outputted by the chess piece recommendation model obtained through training not only helps the game account to win the final victory, but also balances advantages and disadvantages of all the turns, where the recommended chess piece is closer to the state of the current turn.

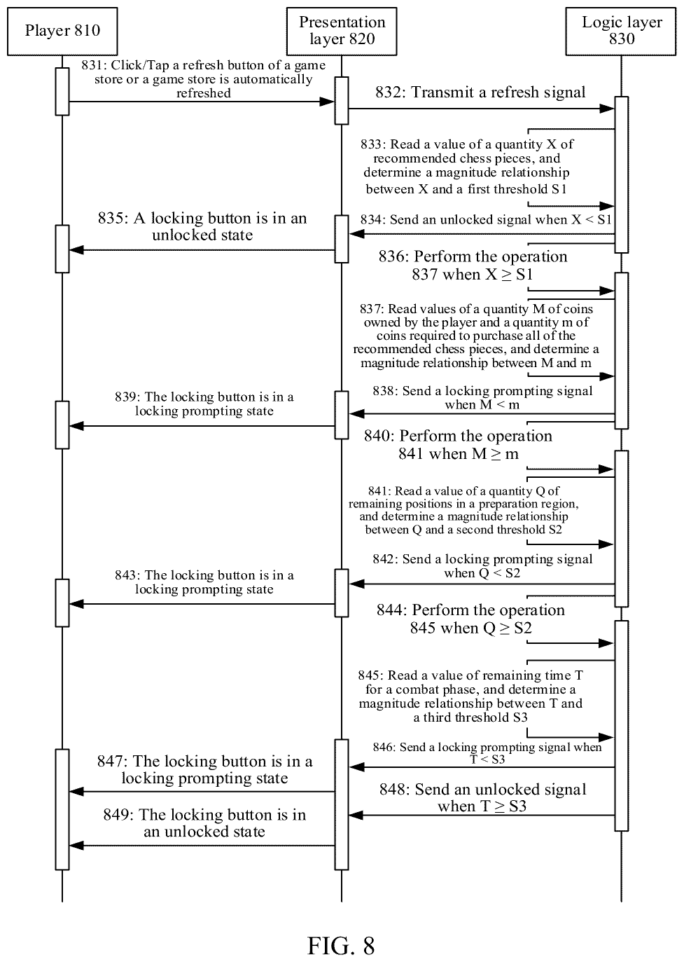

FIG. 8 is a schematic diagram of a game store display method according to an embodiment of this application. The method is performed by a terminal or a game client. The game client includes a presentation layer 820 and a logic layer 830. The method includes the following operations:

### Operation 831:

A player clicks/taps a refresh button of a game store or a game store is automatically refreshed.

In auto chess, the player 810 needs to improve combat effectiveness of a virtual chess piece to defeat the enemy and win the game. The game rule of the auto chess determines that a higher star level of the virtual chess piece indicates higher combat effectiveness. In this case, it is necessary to draw the same virtual chess pieces in the game store for star up. There are multiple virtual chess pieces in the game store each time for the player to choose. To increase a quantity of selectable virtual chess pieces, the player 810 needs to refresh the game store, and may refresh the game store by a method of clicking/tapping the refresh button of the game store or by a method of automatically refreshing the game store at an end of a turn.

### Operation 832:

The presentation layer transmits a refresh signal.

The refresh signal is generated when the player clicks/taps the refresh button of the game store or when the game store is automatically refreshed. The presentation layer 820 transmits the refresh signal to the logic layer 830.

Operation 833: The logic layer reads a value of a quantity X of recommended chess pieces, and determines a magnitude relationship between the quantity X of recommended chess pieces and a first threshold S1.

After receiving the refresh signal, the logic layer 830 reads the value of the quantity of recommended chess pieces. The recommended chess piece includes at least one of a virtual chess piece owned by the player, a virtual chess piece that meets a star up condition, and a virtual chess piece that matches a lineup used by the player.

The logic layer 830 determines the magnitude relationship between the value of the quantity of recommended chess pieces and the first threshold S1, and performs the operation 834 when the quantity of recommended chess pieces is less than the first threshold; or performs the operation 836 when the quantity of recommended chess pieces is greater than or equal to the first threshold.

### Operation 834:

Send an unlocked signal when the quantity of recommended chess pieces is less than the first threshold.

When the quantity of recommended chess pieces is less than the first threshold, the logic layer 830 sends the unlocked signal to the presentation layer 820. Using an example in which the first threshold S1 is 1 for description, when the quantity of recommended chess pieces is less than 1, that is, when there is no recommended chess piece, the logic layer 830 sends the unlocked signal to the presentation layer 820.

For example, in the virtual chess piece for the player to choose in the game store, when there is no virtual chess piece owned by the player, no virtual chess piece that meets the star up condition, and no virtual chess piece that matches the lineup used by the player, that is, when the quantity of recommended chess pieces is 0, the logic layer 830 sends the unlocked signal to the presentation layer 820.

### Operation 835:

The presentation layer places a locking button to be in an unlocked state.

The status of the locking button includes at least one of the following: an unlocked state, a locking prompting state, and a locked state. After receiving the unlocked signal sent by the logic layer 830, the presentation layer 820 places the locking button in the unlocked state, that is, does not give the player a prompt to lock the game store.

### Operation 836:

Perform the operation 837 when the quantity of recommended chess pieces is greater than or equal to the first threshold.

Using an example in which the first threshold S1 is 1 for description, when the quantity of recommended chess pieces is greater than or equal to 1, that is, when there is a recommended chess piece, the operation 837 is performed. For example, as shown in FIG. 2, the game store includes a chess piece A 2220 and a chess piece E 2240, the preparation region includes a chess piece A1 2222 and a chess piece E1 2242, and the combat region includes a chess piece E2 2244. The chess piece A 2220 and the chess piece A1 2222 are different picture representations of one same type of virtual chess pieces. The chess piece E 2240, the chess piece E1 2242, and the chess piece E2 2244 are different picture representations of another same type of virtual chess pieces. In this case, the chess piece A 2220, as the virtual chess piece owned by the player, meets the condition of being a recommended chess piece, and the chess piece E 2240, as the virtual chess piece that meets the star up condition, meets the condition of being a recommended chess piece, so the operation 837 is performed when the quantity of the recommended chess pieces is 2.

### Operation 837:

The logic layer reads values of a quantity M of coins owned by the player and a quantity m of coins required to purchase all of the recommended chess pieces, and determines a magnitude relationship between M and m.

When there are recommended chess pieces, the logic layer 830 reads the values of the quantity of coins owned by the player and the quantity of coins required to purchase all of the recommended chess pieces, and determines the magnitude relationship between the quantity of coins owned by the player and the quantity of coins required to purchase all of the recommended chess pieces:

When the quantity of coins owned by the player is less than the quantity of coins required to purchase all of the recommended chess pieces, the operation 838 is performed. When the quantity of coins owned by the player is greater than or equal to the quantity of coins required to purchase all of the recommended chess pieces, the operation 840 is performed.

### Operation 838:

Send a locking prompting signal when the quantity of coins owned by the player is less than the quantity of coins required to purchase all of the recommended chess pieces.

When the quantity of coins owned by the player is less than the quantity of coins required to purchase all of the recommended chess pieces, the logic layer 830 sends the locking prompting signal to the presentation layer 820.

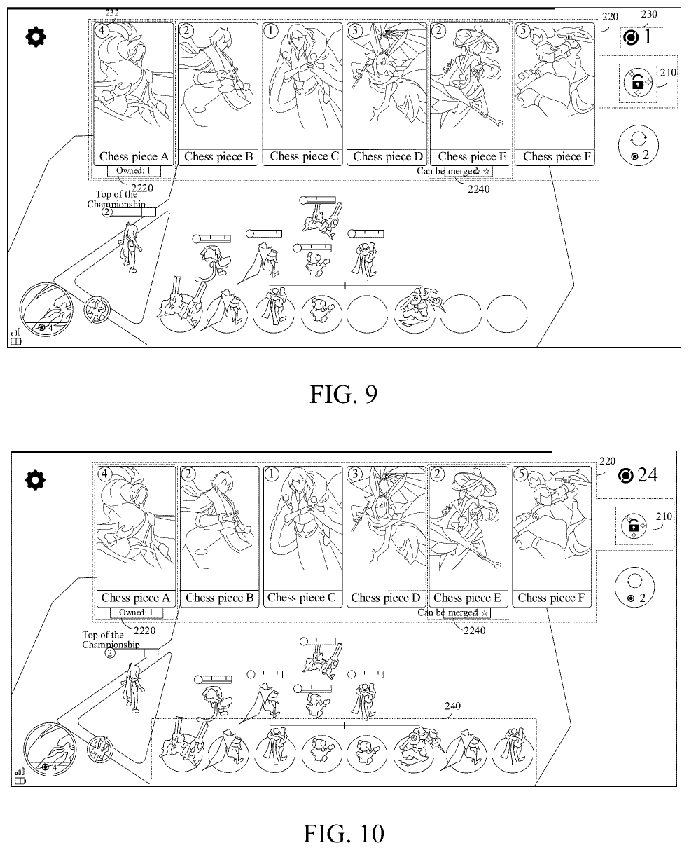

There may be one or more recommended chess pieces. For example, FIG. 9 is a schematic diagram of a game store display method according to an embodiment of this application. The owned coin quantity is 1, the quantity of coins required to purchase the recommended chess piece A 2220 is 4, the quantity of coins required to purchase the recommended chess piece E 2240 is 2, and the quantity of coins required to purchase all of the recommended chess pieces is 6. The player does not have enough coins to purchase all of the recommended chess pieces, then the logic layer 830 sends the locking prompting signal to the presentation layer 820.

### Operation 839:

The presentation layer places the locking button in a locking prompting state.

After receiving the locking prompting signal sent by the logic layer 830, the presentation layer 820 places the locking button in the locking prompting state, that is, gives the player a prompt to lock the game store.

### Operation 840:

Perform the operation 841 when the quantity of coins owned by the player is greater than or equal to the quantity of coins required to purchase all of the recommended chess pieces.

When the quantity of coins owned by the player is greater than or equal to the quantity of coins required to purchase all of the recommended chess pieces, that is, when the player has enough coins to purchase all of the recommended chess pieces, the operation 841 is performed. For example, when there are two recommended chess pieces, the quantity of coins required to purchase the recommended chess piece A is 4, the quantity of coins required to purchase the recommended chess piece E is 2, and the quantity of coins owned by the player is 6. The player has enough coins to purchase all of the recommended chess pieces, then the operation 841 is performed.

### Operation 841:

The logic layer reads a value of a quantity Q of remaining positions in a preparation region, and determines a magnitude relationship between Q and a second threshold S2.

When there are recommended chess pieces, the logic layer 830 reads the value of the quantity of remaining positions in the preparation region, and determines the magnitude relationship between the quantity of remaining positions in the preparation region and the second threshold. When the quantity of remaining positions in the preparation region is less than the second threshold, the operation 842 is performed. When the quantity of remaining positions in the preparation region is greater than or equal to the second threshold, the operation 844 is performed.

### Operation 842:

Send a locking prompting signal when the quantity of remaining positions in the preparation region is less than the second threshold.

Using an example in which the second threshold S2 is 1 for description, when the quantity of remaining positions in the preparation region is less than 1, that is, when there is no empty position in the preparation region, the logic layer 830 sends the locking prompting signal to the presentation layer 820.

For example, FIG. 10 is a schematic diagram of a game store display method according to an embodiment of this application. When there is no remaining position in the preparation region, that is, the quantity of remaining positions in the preparation region is 0, or all positions in the preparation region have virtual chess pieces, that is, the quantity of remaining positions in the preparation region is 0, the logic layer 830 sends the locking prompting signal to the presentation layer 820.

### Operation 843:

The presentation layer places the locking button in a locking prompting state.

After receiving the locking prompting signal sent by the logic layer 830, the presentation layer 820 places the locking button in the locking prompting state, that is, gives the player a prompt to lock the game store.

### Operation 844:

Perform the operation 845 when the quantity of remaining positions in the preparation region is greater than or equal to the second threshold.

Using an example in which the second threshold S2 is 1 for description, when the quantity of remaining positions in the preparation region is greater than or equal to 1, that is, when there is an empty position in the preparation region, the operation 845 is performed. For example, when two positions in the preparation region have no virtual chess pieces, that is, when the quantity of remaining positions in the preparation region is 2, the operation 845 is performed.

### Operation 845:

The logic layer reads the value of remaining time T for a combat phase, and determines a magnitude relationship between T and a third threshold S3.

When there are recommended chess pieces, the logic layer 830 reads the value of the remaining time T for the combat phase. The auto chess game process includes a preparation phase, a combat phase, and a buffer phase. The combat phase is after the preparation phase. The buffer phase is after the combat phase. The preparation phase is after the buffer phase. The remaining time T for the combat phase is calculated by counting down from the time entering the preparation phase. Duration of the buffer phase is buffer time t. The game store is automatically refreshed in the preparation phase to change the virtual chess pieces selectable for the player.

The logic layer 830 determines the magnitude relationship between the remaining time for the combat phase and the third threshold S3, and performs the operation 846 when the remaining time for the combat phase is less than the third threshold; or performs the operation 848 when the remaining time for the combat phase is greater than or equal to the third threshold.

### Operation 846:

Send a locking prompting signal when the remaining time for the combat phase is less than the third threshold.

Using an example in which the third threshold S3 is 0 for description, when the remaining time for the combat phase is less than 0, that is, when there is no remaining time for the combat phase, and the virtual chess piece in the game store is about to be refreshed automatically, the logic layer 830 sends the locking prompting signal to the presentation layer 820.

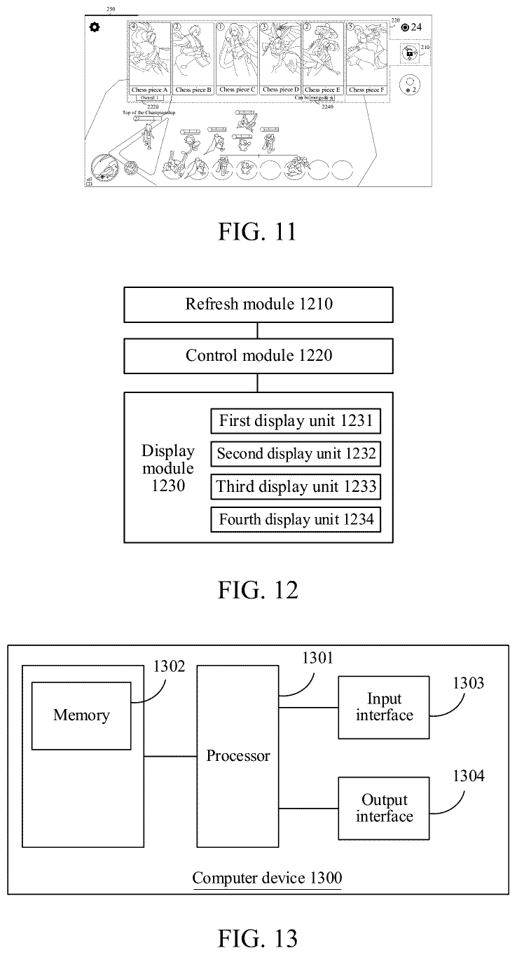

When T<0, the buffer time t>(−T). For example, FIG. 11 is a schematic diagram of a game store display method according to an embodiment of this application. FIG. 11 shows the buffer phase. In this case, the combat phase has ended, the buffer time t is 10 seconds, the remaining time for the combat phase is −5 seconds, there is no remaining time for the combat phase, the virtual chess piece in the game store is about to be refreshed automatically after 5 seconds, and the logic layer 830 sends the locking prompting signal to the presentation layer 820.

In one embodiment, the locking prompting state includes a combination of at least one or more of a blinking state with different blinking frequencies, a blinking state with different blinking brightness, and a blinking state with different blinking colors.

When (−t)<T<0, a smaller value of T indicates a higher blinking frequency. For example, in a case that t is 10 seconds, when T is −3 seconds, the blinking frequency is 2 Hz; or when T is −9 seconds, the blinking frequency is 10 Hz.

When (−t)<T<0, a smaller value of T indicates higher blinking brightness. For example, in a case that t is 10 seconds, when T is −3 seconds, the blinking brightness is 100 nits; or when T is −9 seconds, the blinking brightness is 200 nits.

When (−t)<T<0, a smaller value of T indicates a different blinking color. For example, in a case that t is 10 seconds, when T is −3 seconds, the blinking color is green; or when Tis −9 seconds, the blinking color is red.

### Operation 847:

The presentation layer places the locking button in a locking prompting state.

After receiving the locking prompting signal sent by the logic layer 830, the presentation layer 820 places the locking button in the locking prompting state, that is, gives the player a prompt to lock the game store.

### Operation 848:

Send an unlocked signal when the remaining time for the combat phase is greater than or equal to the third threshold.

Using an example in which the third threshold S3 is 0 for description, when the remaining time for the combat phase is greater than or equal to 0, that is, when there is still remaining time for the combat phase, and the virtual chess piece in the game store is not refreshed automatically, the logic layer 830 sends the unlocked signal to the presentation layer 820. For example, T is 10 seconds, there is still remaining time for the combat phase, the buffer phase has not been entered, the virtual chess piece in the game store is not refreshed automatically, and the logic layer 830 sends the unlocked signal to the presentation layer 820.

### Operation 849:

The presentation layer places the locking button to be in an unlocked state.

After receiving the unlocked signal sent by the logic layer 830, the presentation layer 820 places the locking button in the unlocked state, that is, does not give the player a prompt to lock the game store.

In some embodiments, when there are recommended chess pieces, a sequence of the operations of determining the magnitude relationship between the quantity of the coins owned by the player and the quantity of the coins required to purchase all of the recommended chess pieces, determining the magnitude relationship between the quantity of the remaining positions in the preparation region and the second threshold, and determining the magnitude relationship between the remaining time for the combat phase and the third threshold is adjustable. Details are not described herein again.

In conclusion, in the method provided in this embodiment, by determining whether there are recommended chess pieces, when there are recommended chess pieces, the prompt of locking the game store is given to the player, so that the player can purchase the desired virtual chess piece after a purchase condition is met, avoiding missing the desired virtual chess piece.

In the method provided in this embodiment, the magnitude relationship between the quantity of the virtual resources owned by the first game account and the quantity of the virtual resources required to purchase all of the recommended chess pieces is further determined. When the quantity of the virtual resources owned by the first game account is less than the quantity of the virtual resources required to purchase all of the recommended chess pieces, the prompt of locking the game store is given to the player, so that the player can purchase the desired virtual chess piece after a purchase condition is met, avoiding missing the desired virtual chess piece.

In the method provided in this embodiment, the magnitude relationship between the quantity of the remaining positions in the preparation region and the second threshold is further determined. When the quantity of the remaining positions in the preparation region is less than the second threshold, the prompt of locking the game store is given to the player, so that the player can purchase the desired virtual chess piece after a purchase condition is met, avoiding missing the desired virtual chess piece.

In the method provided in this embodiment, the magnitude relationship between the remaining time for the combat phase and the third threshold is further determined. When the remaining time for the combat phase is less than the third threshold, the prompt of locking the game store is given to the player, so that the player can purchase the desired virtual chess piece after a purchase condition is met, avoiding missing the desired virtual chess piece.

FIG. 12 is a block diagram of a game store display apparatus according to an embodiment of this application. The apparatus includes: a refresh module 1210, a control module 1220, and a display module 1230.

The refresh module 1210 is configured to refresh, based on a refresh condition in a game process of a turn-based chess game, a virtual chess piece for sale in the game store for display.

The control module 1220 is configured to control, in response to a purchase operation and a game operation, a first game account to participate in a turn in the turn-based chess game using a purchased virtual chess piece.

The display module 1230 is configured to display, when the game store meets a locking prompting condition, prompt information that suggests configuring the game store to be in a locked state, the locked state being a state in which the game store locks a virtual chess piece for sale without refreshing within locking duration.

In one embodiment, the display module 1230 is configured to display, when a quantity of recommended chess pieces in the game store meets the locking prompting condition, the prompt information that suggests configuring the game store to be in the locked state. The recommended chess pieces are virtual chess pieces recommended in the game store to the first game account for purchase.

In one embodiment, the display module 1230 is configured to display, when the quantity of the recommended chess pieces in the game store and a game parameter of the first game account meet the locking prompting condition, the prompt information that suggests configuring the game store to be in the locked state.

In one embodiment, the game parameter includes at least one of the following: a quantity of virtual resources owned by the first game account; a quantity of virtual resources required to purchase all of the recommended chess pieces; a quantity of remaining positions in a preparation region; and remaining time for a combat phase. The virtual resources are resources for purchasing the virtual chess piece in the turn-based chess game; the preparation region is a region storing the virtual chess piece; and the combat phase is a phase in a turn in the turn-based chess game.

In one embodiment, the display module 1230 includes a first display unit 1231, a second display unit 1232, a third display unit 1233, and a fourth display unit 1234.

The first display unit 1231 is configured to display, when the quantity of the recommended chess pieces in the game store is greater than or equal to a first threshold, the prompt information that suggests configuring the game store to be in the locked state.

The second display unit 1232 is configured to display, when the quantity of the recommended chess pieces in the game store is greater than or equal to a first threshold, and the quantity of the virtual resources owned by the first game account is less than the quantity of the virtual resources required to purchase all of the recommended chess pieces, the prompt information that suggests configuring the game store to be in the locked state.

The third display unit 1233 is configured to display, when the quantity of the recommended chess pieces in the game store is greater than or equal to a first threshold, and the quantity of the remaining positions in the preparation region is less than a second threshold, the prompt information that suggests configuring the game store to be in the locked state.

The fourth display unit 1234 is configured to display, when the quantity of the recommended chess pieces in the game store is greater than or equal to a first threshold, and the remaining time for the combat phase is less than a third threshold, the prompt information that suggests configuring the game store to be in the locked state.

In one embodiment, the display module 1230 is further configured to display a locking button in a blinking state, the locking button being configured to place the game store in the locked state when a trigger operation is received.

In one embodiment, a blinking parameter of the blinking state is related to remaining time T for a combat phase, and the blinking parameter includes at least one of a frequency, brightness, and a color.

In one embodiment, the display module 1230 is further configured to automatically configure, when the game store meets an automatic locking condition, the game store to be in the locked state.

FIG. 13 is a schematic diagram of a structure of a computer device 1300 according to an embodiment of this application. The computer device 1300 includes: a processor 1301 and a memory 1302.

The processor 1301 may include one or more processing cores, for example, a 4-core processor or an 8-core processor. The processor 1301 may be implemented in at least one hardware form of digital signal processing (DSP), a field-programmable gate array (FPGA), and a programmable logic array (PLA). The processor 1301 may also include a main processor and a coprocessor. The main processor is a processor configured to process data in an awake state, and is also referred to as a central processing unit (CPU). The coprocessor is a low-power-consumption processor configured to process data in a standby state. In some embodiments, the processor 1301 may be integrated with a graphics processing unit (GPU). The GPU is configured to render and draw content that needs to be displayed on a display screen. In some embodiments, the processor 1301 may further include an artificial intelligence (AI) processor. The AI processor is configured to process computing operations related to machine learning.

The memory 1302 may include one or more computer-readable storage media. The computer-readable storage medium may be non-transient. The memory 1302 may further include a high-speed random access memory and a nonvolatile memory, for example, one or more disk storage devices or flash storage devices. In some embodiments, the non-transient computer-readable storage medium in the memory 1302 is configured to store at least one instruction, and the at least one instruction is configured to be executed by the processor 1301 to implement the game store display method provided in the method embodiments of this application.

In some embodiments, the computer device 1300 may further include: an input interface 1303 and an output interface 1304. The processor 1301, the memory 1302, and the input interface 1303 or the output interface 1304 may be connected through a bus or a signal cable. Each peripheral may be connected to the input interface 1303 and the output interface 1304 through a bus, a signal cable, or a circuit board. The input interface 1303 and the output interface 1304 may be configured to connect at least one peripheral related to input/output (I/O) to the processor 1301 and the memory 1302. In some embodiments, the processor 1301, the memory 1302, the input interface 1303, and the output interface 1304 are integrated on the same chip or circuit board. In some other embodiments, any one or two of the processors 1301, the memory 1302, the input interface 1303, and the output interface 1304 may be implemented on a single chip or circuit board. This is not limited in the embodiments of this application.

A person skilled in the art may understand that the structure shown above constitutes no limitation on the computer device 1300, and the computer device 1300 may include more or fewer components than those shown in the figure, or some components may be combined, or a different component deployment may be used.

An embodiment further provides a computer program product. The computer program product includes computer instructions. The computer instructions are stored in a computer-readable storage medium. A processor of a computer device reads the computer instructions from the computer-readable storage medium. The processor reads the computer instructions from the computer-readable storage medium and executes the computer instructions, to implement the game store display method provided in the foregoing method embodiments.

An embodiment further provides a computer-readable storage medium. The computer-readable storage medium stores a computer program. The computer program is loaded and executed by a processor to implement the game store display method provided in the foregoing method embodiments.

What is claimed is:

1. A game store display method, the method being performed by a terminal, and the method comprising:
refreshing a display of a virtual chess piece for sale in the game store based on a refresh condition in a turn-based chess game;
controlling a first game account to participate in a turn in the turn-based chess game using a purchased virtual chess piece in response to a purchase operation and a game operation; and
displaying prompt information that suggests configuring the game store to be in a locked state when the game store meets a locking prompting condition, wherein the locked state is a state in which the game store locks a virtual chess piece for sale without refreshing within locking duration.

2. The method according to claim 1, wherein the displaying prompt information that suggests configuring the game store to be in a locked state when the game store meets a locking prompting condition comprises:
displaying the prompt information that suggests configuring the game store to be in the locked state when a quantity of recommended chess pieces in the game store meets the locking prompting condition, the recommended chess pieces being virtual chess pieces recommended in the game store to the first game account.

3. The method according to claim 2, wherein the displaying the prompt information that suggests configuring the game store to be in the locked state when a quantity of recommended chess pieces in the game store meets the locking prompting condition comprises:
displaying the prompt information that suggests configuring the game store to be in the locked state when the quantity of the recommended chess pieces in the game store and a game parameter of the first game account meet the locking prompting condition.

4. The method according to claim 3, wherein the game parameter comprises at least one of the following:
a quantity of virtual resources owned by the first game account;
a quantity of virtual resources required to purchase all of the recommended chess pieces;
a quantity of remaining positions in a preparation region; and
remaining time for a combat phase,
the virtual resources being resources for purchasing the virtual chess piece in the turn-based chess game; the preparation region being a region storing the virtual chess piece; and the combat phase being a phase in a turn in the turn-based chess game.

5. The method according to claim 2, wherein the displaying the prompt information that suggests configuring the game store to be in the locked state when a quantity of recommended chess pieces in the game store meets the locking prompting condition comprises:
displaying the prompt information that suggests configuring the game store to be in the locked state when the quantity of the recommended chess pieces in the game store is greater than or equal to a first threshold.

6. The method according to claim 3, wherein the displaying the prompt information that suggests configuring the game store to be in the locked state when the quantity of the recommended chess pieces in the game store and a game parameter of the first game account meet the locking prompting condition comprises:
displaying the prompt information that suggests configuring the game store to be in the locked state when the quantity of the recommended chess pieces in the game store is greater than or equal to a first threshold, and the quantity of the virtual resources owned by the first game account is less than the quantity of the virtual resources required to purchase all of the recommended chess pieces.

7. The method according to claim 3, wherein the displaying the prompt information that suggests configuring the game store to be in the locked state when the quantity of the recommended chess pieces in the game store and a game parameter of the first game account meet the locking prompting condition comprises:
displaying the prompt information that suggests configuring the game store to be in the locked state when the quantity of the recommended chess pieces in the game store is greater than or equal to a first threshold, and the quantity of the remaining positions in the preparation region is less than a second threshold.

8. The method according to claim 3, wherein the displaying the prompt information that suggests configuring the game store to be in the locked state when the quantity of the recommended chess pieces in the game store and a game parameter of the first game account meet the locking prompting condition comprises:
displaying the prompt information that suggests configuring the game store to be in the locked state when the quantity of the recommended chess pieces in the game store is greater than or equal to a first threshold, and the remaining time for the combat phase is less than a third threshold.

9. The method according to claim 1, wherein the displaying prompt information that suggests configuring the game store to be in a locked state comprises:
displaying a locking button in a blinking state, the locking button being configured to place the game store to be in the locked state when a trigger operation is received.

10. The method according to claim 9, wherein a blinking parameter of the blinking state is related to remaining time for a combat phase, and the blinking parameter comprises at least one of a frequency, brightness, and a color.

11. The method according to claim 1, further comprising:
automatically configuring the game store to be in the locked state when the game store meets an automatic locking condition.

12. The method according to claim 2, wherein the recommended chess pieces comprise at least one of the following:
a virtual chess piece owned by the first game account;
a virtual chess piece that meets an upgrade condition, upgrade being a process of merging, when N same virtual chess pieces exist in the game, the N same virtual chess pieces into a virtual chess piece of a higher level, N being a positive integer; and
a virtual chess piece that matches a lineup used by the first game account.

13. The method according to claim 2, further comprising:
inputting status information of the first game account in a current turn to a chess piece recommendation model; and
performing prediction through the chess piece recommendation model to obtain the recommended chess pieces,
the status information comprising at least one of a type, quantity, and level of a virtual chess piece owned by the first game account in the current turn, a hit point of the first game account, and a quantity of virtual resources owned by the first game account.

14. The method according to claim 13, further comprising:
obtaining a plurality of sets of battle data of a plurality of sample game accounts, the plurality of sets of battle data and the plurality of sample game accounts being in a one-to-one correspondence, and one set of battle data comprising data of one battle; and
training, for one of the plurality of sample game accounts, the chess piece recommendation model based on battle data of the sample game account.

15. The method according to claim 14, wherein the training the chess piece recommendation model based on battle data of the sample game account comprises:
inputting, for a (j+1)^{th} turn, status information of the sample game account at an end of a j^{th} turn to the chess piece recommendation model, and outputting a (j+1)^{th} recommended chess piece through the chess piece recommendation model;
obtaining status information of the sample game account at an end of the (j+1)^{th} turn;
generating a (j+1)^{th} turn loss based on the status information of the sample game account at the end of the j^{th} turn, the status information of the sample game account at the end of the (j+1)^{th} turn, and indication information of whether the sample game account purchases the (j+1)^{th} recommended chess piece in the (j+1)^{th} turn;
generating a plurality of turn losses for a plurality of turns comprised in one battle;
generating one battle loss for one battle, the battle loss being a loss generated based on a battle winning state of the sample game account; and
training the chess piece recommendation model based on the plurality of turn losses and the battle loss.

16. A computer device, comprising: a processor and a memory, the memory storing a computer program, and the computer program being loaded and executed by the processor to implement a game store display method, and the method comprising:
refreshing a display of a virtual chess piece for sale in the game store based on a refresh condition in a turn-based chess game;
controlling a first game account to participate in a turn in the turn-based chess game using a purchased virtual chess piece in response to a purchase operation and a game operation; and
displaying prompt information that suggests configuring the game store to be in a locked state when the game store meets a locking prompting condition, wherein the locked state is a state in which the game store locks a virtual chess piece for sale without refreshing within locking duration.

17. The computer device according to claim 16, wherein the displaying prompt information that suggests configuring the game store to be in a locked state when the game store meets a locking prompting condition comprises:
displaying the prompt information that suggests configuring the game store to be in the locked state when a quantity of recommended chess pieces in the game store meets the locking prompting condition, the recommended chess pieces being virtual chess pieces recommended in the game store to the first game account.

18. The computer device according to claim 17, wherein the displaying the prompt information that suggests configuring the game store to be in the locked state when a quantity of recommended chess pieces in the game store meets the locking prompting condition comprises:
displaying the prompt information that suggests configuring the game store to be in the locked state when the quantity of the recommended chess pieces in the game store and a game parameter of the first game account meet the locking prompting condition.

19. A non-transitory computer-readable storage medium, storing a computer program, the computer program being loaded and executed by a processor to implement a game store display method, and the method comprising:
refreshing a display of a virtual chess piece for sale in the game store based on a refresh condition in a turn-based chess game;
controlling a first game account to participate in a turn in the turn-based chess game using a purchased virtual chess piece in response to a purchase operation and a game operation; and
displaying prompt information that suggests configuring the game store to be in a locked state when the game store meets a locking prompting condition, wherein the locked state is a state in which the game store locks a virtual chess piece for sale without refreshing within locking duration.

20. The computer-readable storage medium according to claim 19, wherein the displaying prompt information that suggests configuring the game store to be in a locked state when the game store meets a locking prompting condition comprises:
displaying the prompt information that suggests configuring the game store to be in the locked state when a quantity of recommended chess pieces in the game store meets the locking prompting condition, the recommended chess pieces being virtual chess pieces recommended in the game store to the first game account.
